(19) United States
(12) Patent Application Publication
(10) Pub. No.: US 2014/0136526 A1
(43) Pub. Date: May 15, 2014

(54) DISCOVERY OF LIVE AND ON-DEMAND CONTENT USING METADATA

(71) Applicant: MOBILTV, INC., Emeryville, CA (US)

(72) Inventor: Curtis Calhoun, El Sobrante, CA (US)

(73) Assignee: MobiTV, Inc., Emeryville, CA (US)

(21) Appl. No.: 13/674,733

(22) Filed: Nov. 12, 2012

(51) Int. Cl. G06F 17/30

(52) U.S. Cl. 707/723; 707/E17.082

(57) ABSTRACT

Mechanisms are provided to allow for content discovery using closed caption content search and ranking. Search mechanisms analyze titles, descriptions, social media content, metadata, etc., and intelligently organize content for presentation to a viewer. Image recognition and audio recognition algorithms can also be performed to further identify entities or validate results from the analysis of metadata. Other closed captioning content may be analyzed to determine the relevance of a piece of media content to a particular search term found in the piece of media content. Results are ranked based on the prominence of search and related terms in titles, descriptions, and closed caption contents along with the popularity of the media content itself.

### TECHNICAL FIELD

The present disclosure relates to discovery of live and on-demand content using metadata.

### DESCRIPTION OF RELATED ART

A variety of conventional mechanisms allow for discovery of media content. In some examples, search engines allow for discovery of keywords in title data and description data to identify content relevant to search terms. Viewers may also browse media content that may be divided into chapters, with thumbnail images providing information about scenes included in each chapter. Viewers can also fast forward and/or rewind through media content such as video clips and live streams. However, fast forward and/or rewind through media content can be highly inefficient.

Other pieces of media content include bookmarks and chapter titles to allow for more efficient navigation. These bookmarks may be preset or supplemented with user bookmarks. However, all of these mechanisms have significant drawbacks. Consequently, techniques and mechanisms are provided to improve media content discovery.

### BRIEF DESCRIPTION OF THE DRAWINGS

The disclosure may best be understood by reference to the following description taken in conjunction with the accompanying drawings, which illustrate particular embodiments.

FIG. 1 illustrates one example of a system that can use the techniques and mechanisms of the present invention.

FIGS. 2A and 2B illustrate examples of a media search and discovery screens.

FIG. 3 illustrates one example of a technique for discovering media content.

FIG. 4 illustrates one example of a technique for performing media content discovery.

FIG. 5 illustrates one example of a computer system.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular operations and types of content. However, it should be noted that the techniques of the present invention apply to a variety of operations and types of content. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### OVERVIEW

Mechanisms are provided to allow for content discovery using closed caption content search and ranking. Search mechanisms analyze titles, descriptions, social media content, metadata, etc., and intelligently organize content for presentation to a viewer. Image recognition and audio recognition algorithms can also be performed to further identify entities or validate results from the analysis of metadata. Other closed captioning content may be analyzed to determine relevance of a piece of media content to a particular search term found in the piece of media content. Results are ranked based on prominence of search and related terms in titles, description, and closed caption content along with the popularity of the media content itself.

### EXAMPLE EMBODIMENTS

Conventional media search and discovery mechanisms are limited. A user conventionally has to fast forward and/or rewind through media content such as video clips and live streams. In some instances, the user can access skip forward or skip backward operations. Media content providers sometimes include tags or chapter titles and delineations to allow more efficient navigation. Title and content description information may also highlight particular time markers that may be associated with a particular entity.

Information is typically provided at the channel, show, and episode level with title, content description, and possibly show snapshots presented to a user often in grid-type formats. A user navigates to a particular channel, show, and episode and selects the episode to begin playback of that episode. In some instances, video clips are provided with show snapshots, title, and content description and playback begins with selection of the title or snapshot.

However, conventional mechanisms for content discovery are usually limited to the content listing level. For example, if a viewer wants to find video clips depicting squirrels, the viewer may navigate to time slots and select particular episodes of nature-related programs. The episodes may or may not feature squirrels. The user would then have to browse through a selection of show titles, if available, to guess which shows might feature squirrels. In some instances, there may be websites that feature squirrels and fans may have indicated where media segments depicting squirrels can be located. However, out-of-band search still does not allow easy access to shows, clips, segments, or snapshots in shows featuring squirrels.

Consequently, the techniques and mechanisms of the present invention analyze media content metadata such as closed captions to allow for text-based search of media content. According to various embodiments, searches analyze titles, description, social media data, closed caption content, and closed caption content contextual data to identify media content relevant to search terms. In some examples, a search term will return a movie with the search term in the title, clips of media programs with the search terms prominently used in the caption data, clips of media program with contextual terms related to the search terms used in the caption data, descriptions of media content including the search terms or related terms, etc.

In particular embodiments, search results are displayed as a listing of content highlighting the presence of the search terms or related terms in different fields of the media content. In some examples, a search term may reside in a title field, a description field, closed caption content, or closed caption content contextual data.

According to various embodiments, image recognition and audio recognition algorithms can be used in lieu of or to augment metadata search results. In some instances, video can be analyzed manually to identify entities such as characters, objects, emotions, types of scenes, etc. Closed caption content or closed captioning content can also be analyzed for context associated with the search terms to further highlight the importance of search terms in particular media content.

In particular embodiments, search results return content having search terms in different types of fields such as the title, description, closed captioning content, social media content, etc., ranked based on prevalence of the term and the importance of the field. In some examples, a result with a search term in the title would be ranked higher than a result with the search term in associated social media content or reviewer critiques. In other examples, a result with the search term in the closed captioning content would appear first if the term both appeared numerous times in closed captioning content and contextual keywords also appeared alongside. For example, “Eucalyptus tree” appearing in closed caption content would rank a result higher if the term “Eucalyptus tree” appeared alongside common associated keywords like grove, forest, Koala, poisonous, leaves, etc. In still other examples, results are ranked based on a combination of the importance of the field, prominence of the term in the field, popularity of the content, and the contextual confirmation of the term in the field.

According to various embodiments, results include title listings, descriptions, as well as content with time markers indicating where search terms are located in closed caption content. Users need not select the content and subsequently browse through the content to locate relevant portions. Instead, relevant portions of content are highlighted for immediate selection in a search results page.

For example, closed captioning content may indicate that Eucalyptus trees are depicted at time positions 14:10-14:45 and 21:05-22:13. Image recognition, audio recognition, and contextual clues may confirm this determination. Markers allowing selection of these portions or segments of content may be readily selected in a search results page. Media segments may be mere 5 second segments or run far longer. Multiple media segments may be identified using snapshots on a timeline, displayed as thumbnails in a grid, depicted in short segment sequences on a mosaic, and provided with other text, title, and description based search results. Analysis of closed caption content allow for robust search and discovery

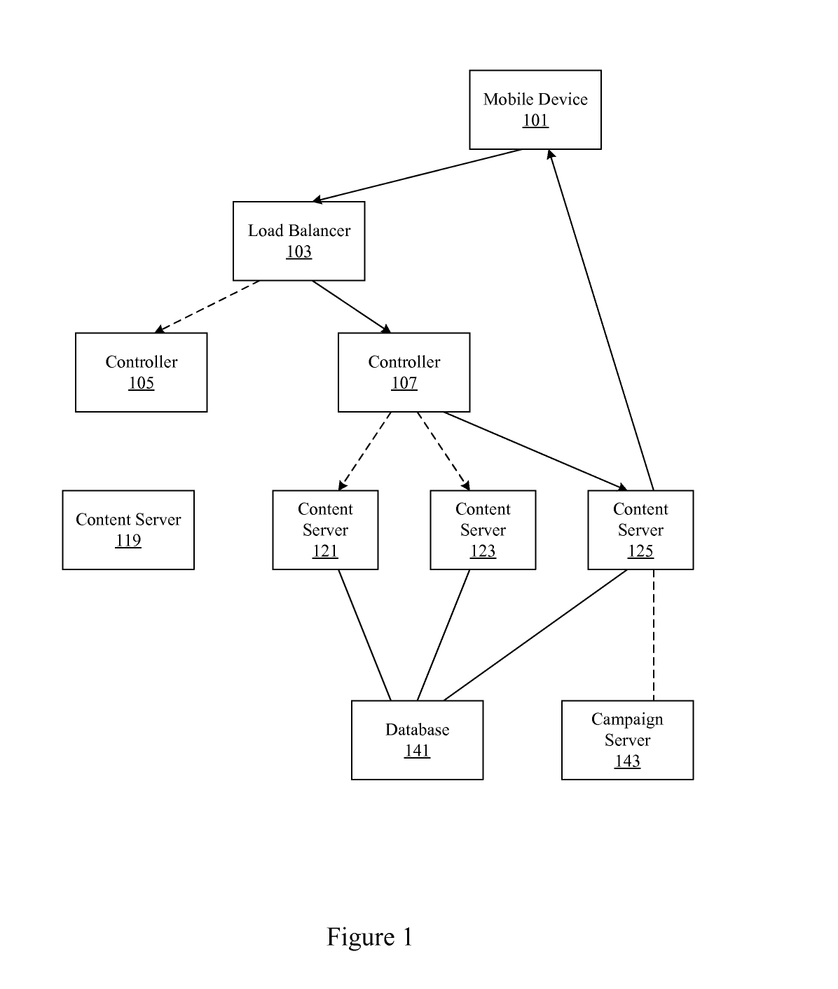

FIG. 1 is a diagrammatic representation illustrating one example of a system that can use the techniques and mechanisms of the present invention. According to various embodiments, content servers 119, 121, 123, and 125 are configured to provide media content to a mobile device 101. In some examples, media content may be provided using protocols such as HTTP, RTP, and RTCP. Although a mobile device 101 is shown, it should be recognized that other devices such as set top boxes and computer systems can also be used. In particular examples, the content servers 119, 121, 123, and 125 can themselves establish sessions with mobile devices and stream video and audio content to mobile devices. However, it is recognized that in many instances, a separate controller such as controller 105 or controller 107 can be used to perform session management using a protocol such as RTSP. It is recognized that content servers require the bulk of the processing power and resources used to provide media content to mobile devices. Session management itself may include far fewer transactions. Consequently, a controller can handle a far larger number of mobile devices than a content server can. In some examples, a content server can operate simultaneously with thousands of mobile devices, while a controller performing session management can manage millions of mobile devices simultaneously.

By separating out content streaming and session management functions, a controller can select a content server geographically close to a mobile device 101. It is also easier to scale, as content servers and controllers can simply be added as needed without disrupting system operation. A load balancer 103 can provide further efficiency during session management by selecting a controller with low latency and high throughput.

According to various embodiments, the content servers 119, 121, 123, and 125 have access to a campaign server 143. The campaign server 143 provides profile information for various mobile devices 101. In some examples, the campaign server 143 is itself a content server or a controller. The campaign server 143 can receive information from external sources about devices such as mobile device 101. The information can be profile information associated with various users of the mobile device including interests and background. The campaign server 143 can also monitor the activity of various devices to gather information about the devices. The content servers 119, 121, 123, and 125 can obtain information about the various devices from the campaign server 143. In particular examples, a content server 125 uses the campaign server 143 to determine what type of media clips a user on a mobile device 101 would be interested in viewing.

According to various embodiments, the content servers 119, 121, 123, and 125 can also receive media streams from content providers such as satellite providers or cable providers and send the streams to devices. In particular examples, content servers 119, 121, 123, and 125 access database 141 to obtain desired content that can be used to supplement streams from satellite and cable providers. In one example, a mobile device 101 requests a particular stream. A controller 107 establishes a session with the mobile device 101 and the content server 125 begins streaming the content to the mobile device 101. In particular examples, the content server 125 obtains profile information from campaign server 143.

In some examples, the content server 125 can also obtain profile information from other sources, such as from the mobile device 101 itself. Using the profile information, the content server 125 can select a clip from a database 141 to provide to a user. In some instances, the clip is injected into a live stream without affecting mobile device application performance. In other instances, the live stream itself is replaced with another live stream. The content server handles processing to make the transition between streams and clips seamless from the point of view of a mobile device application. In still other examples, advertisements from a database 141 can be intelligently selected using profile information from a campaign server 143 and used to seamlessly replace default advertisements in a live stream. Content servers 119, 121, 123, and 125 have the capability to manipulate packets to allow introduction and removal of media content, tracks, metadata, etc.

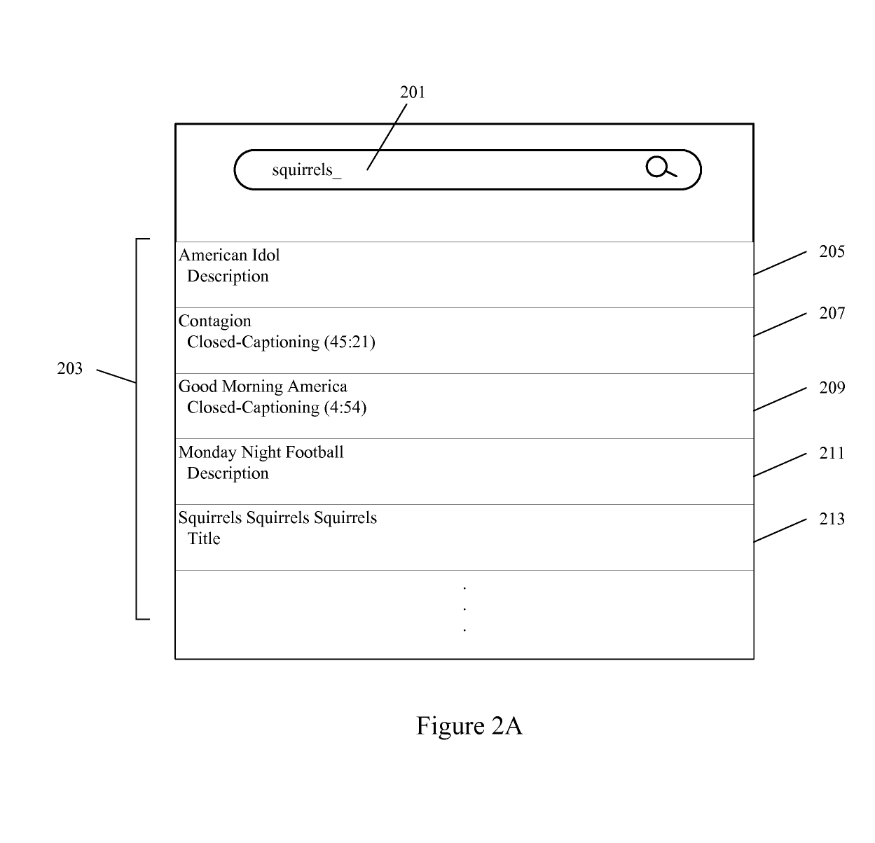

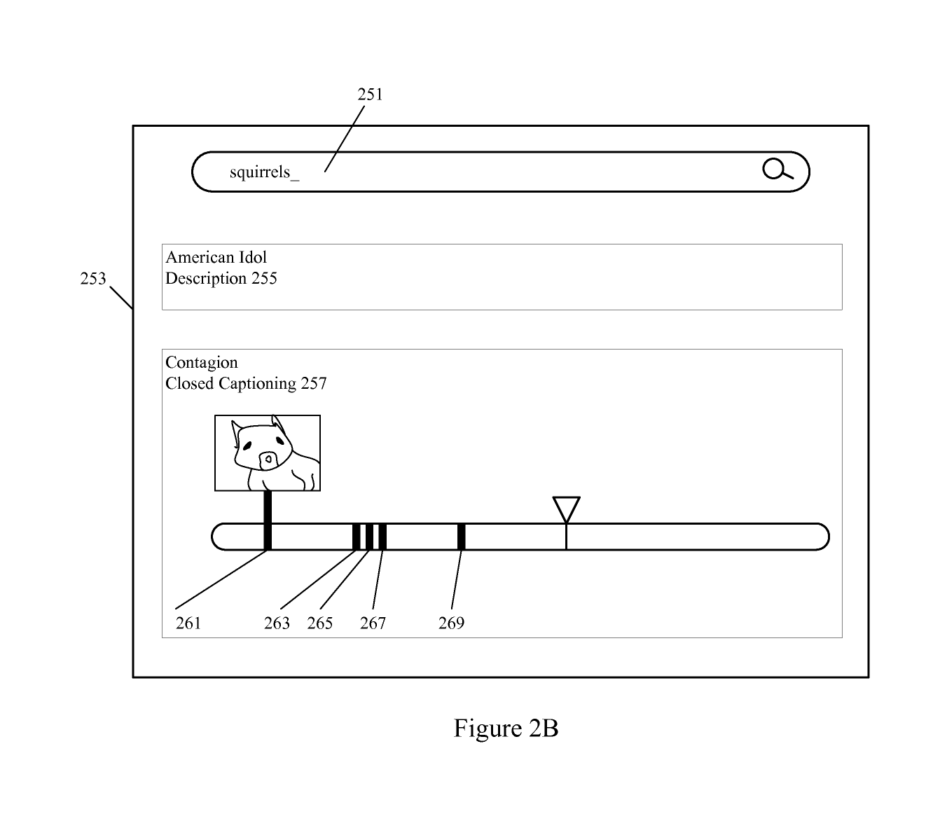

FIG. 2A illustrates one example of a media content search and discovery screen showing ranked results. According to various embodiments, a search using search term 201 provides ranked results 203 corresponding to the search term. The ranked results 203 include a result 205 with a description corresponding to the search term 201. The description may include the search term 201, may include contextual terms related to the search term 201, or both. Selecting the result 205 may direct a user to the content described. According to various embodiments, result 207 shows a media segment corresponding to the search term 201. Result 207 may have the search term 201 included in closed caption content at time 45:21. In particular embodiments, result 209 similarly shows a media segment corresponding to the search term 201, with content relevant to the search term 201 located at 4:54.

In particular embodiments, result 205 may be ranked higher than result 207 or result 209 because the content corresponding to result 205 may be more popular than content corresponding to result 207 or result 209. In some examples, the content may be more popular for a demographic profile corresponding to the user. In still other examples, the content may be more popular with the user based on the user's past content viewing characteristics and preferences.

According to various embodiments, result 211 may have the search term 201 included in its description. In some examples, a result may indicate that a search term is included in its title, description, closed caption content, and social media content. Result 213 may have the search term 201 included in its title multiple times, but the result 213 may be ranked relatively low because of the media content may not be popular or frequently accessed.

FIG. 2B depicts another example of media content search and discovery using ranked results. According to various embodiments, a search using search term 251 provides ranked results 253 corresponding to the search term. The ranked results 253 include a result 255 with a description corresponding to the search term 251. The description may include the search term 251, may include contextual terms related to the search term 251, or both. Selecting the result 255 may direct a user to the content described. According to various embodiments, result 257 shows media segments in a piece of media content corresponding to the search term 251. Result 257 may have the search term 201 included in closed caption content at various time positions. According to various embodiments, result 257 may include search term related content at time positions 261, 263, 265, 267, and 269. Selecting a particular time position 261, 263, 265, 267, and 269 presents the viewer with a thumbnail and/or the actual media content itself. In other examples, selecting the particular time position presents the viewer of a snapshot of the closed caption content including material relevant to the search term 251. According to various embodiments, the thumbnails may correspond to time positions in different pieces of media content such as different shows, movies, video clips, programs, etc. In some examples, an additional sidebar may depict squirrels in a variety of different programs and different time positions in the different programs.

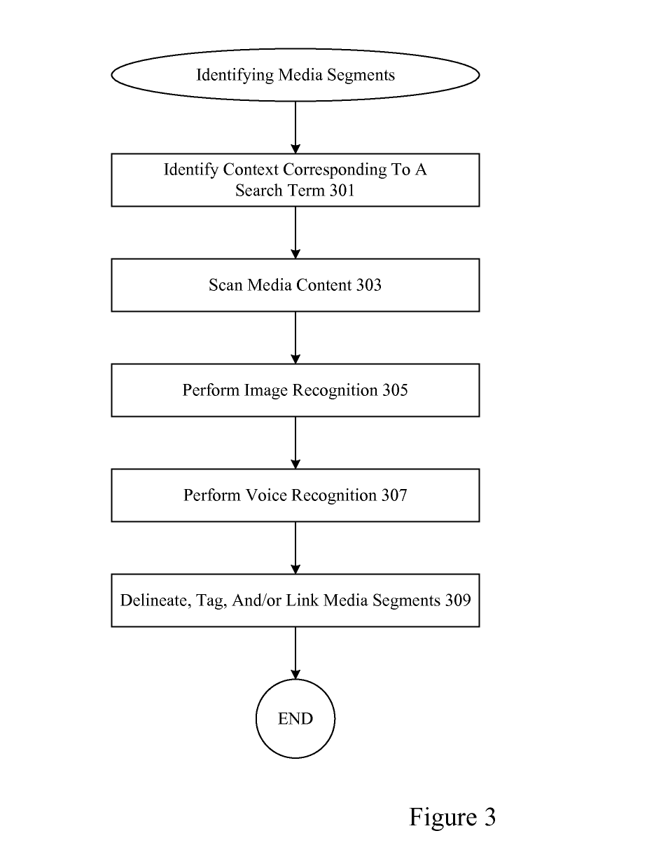

FIG. 3 illustrates one example of a technique for performing media content discovery. According to various embodiments, a media content search and discovery system identifies context corresponding to a search term at 301. For example, the terms mammal, nuts, tree, acorn, tail, furry, may be contextual terms corresponding to a search term squirrel. According to various embodiments, media content from a source such as a media content library is scanned at 303. The scan may be performed by analyzing metadata such as closed captioning, social network commentary, and chat data. The media content may also be scanned manually or by using image recognition and voice recognition algorithms to identify particular search terms or contextual terms. In some examples, image recognition is performed at 305 and voice recognition is performed at 307 to identify entities.

According to various embodiments, media segments are delineated, tagged, and/or linked at 309. In some instances, media segments may be delineated by specifying start points and end points. In other examples, only start points are identified. Tags or markers may include character names, entity names, and likelihood of relevance. In some instances, segments may have tags associated with multiple entities. In some examples, media segments are ordered based on relevance. A search for a particular entity may begin playback of a media segment having the highest relevance with that entity.

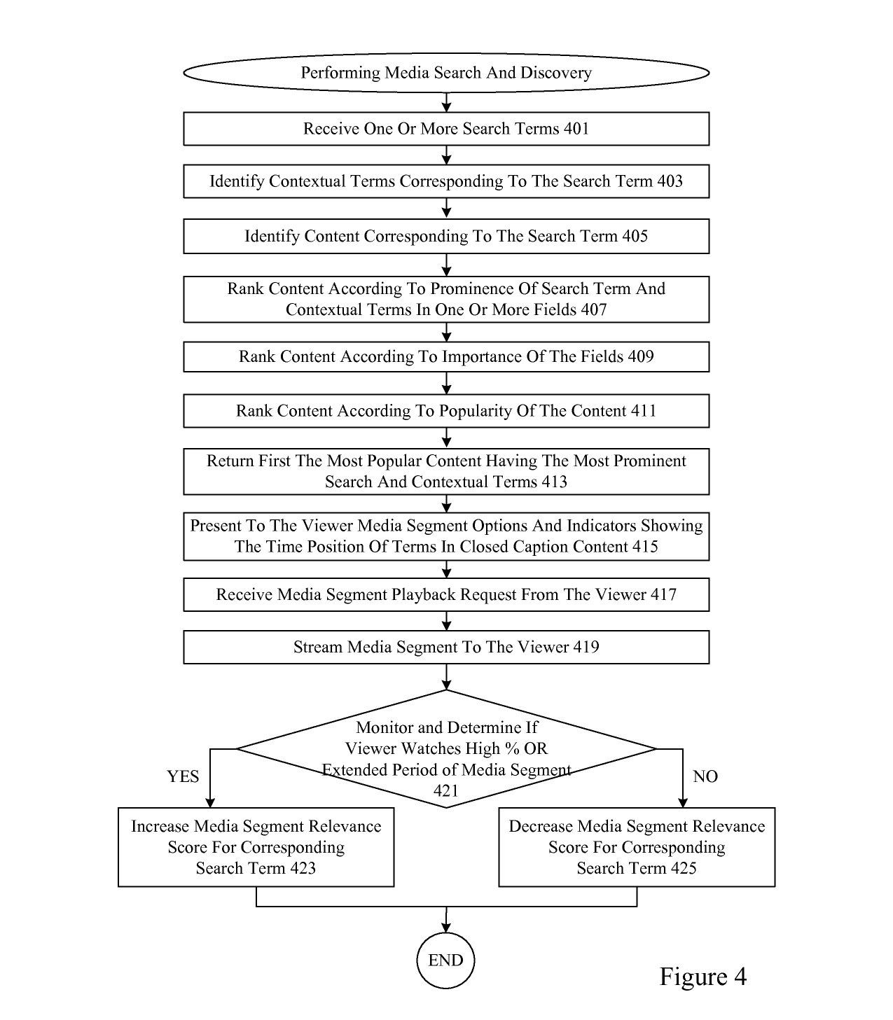

FIG. 4 illustrates a particular example of a technique for performing media search and discovery. According to various embodiments, one or more search terms are received at 401. At 403, contextual terms corresponding to the search term are identified. At 405, content corresponding to the search term are identified. Content may include the search term in the fields such as title, description, closed caption content, social media content, etc. According to various embodiments, the content is ranked using a combination of factors including prominence of the search term and contextual terms in one or more fields at 407, importance of the fields at 409, and popularity of the content at 411. At 413, the most popular content having the most prominent search and contextual terms are returned first. Media segment options may be presented to the viewer along with indicators showing the time position of terms in closed caption content at 415.

According to various embodiments, a media segment playback request is received from the viewer at 417 and the media segment is streamed to the viewer at 419. According to various embodiments, the duration the viewer watches the media segment is monitored to determine how relevant the media segment was to the user at 421. If the viewer watches a high percentage of the media segment or watches for an extended period of time, the media segment relevance score for the corresponding search term is increased at 423. If the viewer watches a low percentage of the media segment or watches for a limited period of time, the media segment relevance score may be decreased at 425.

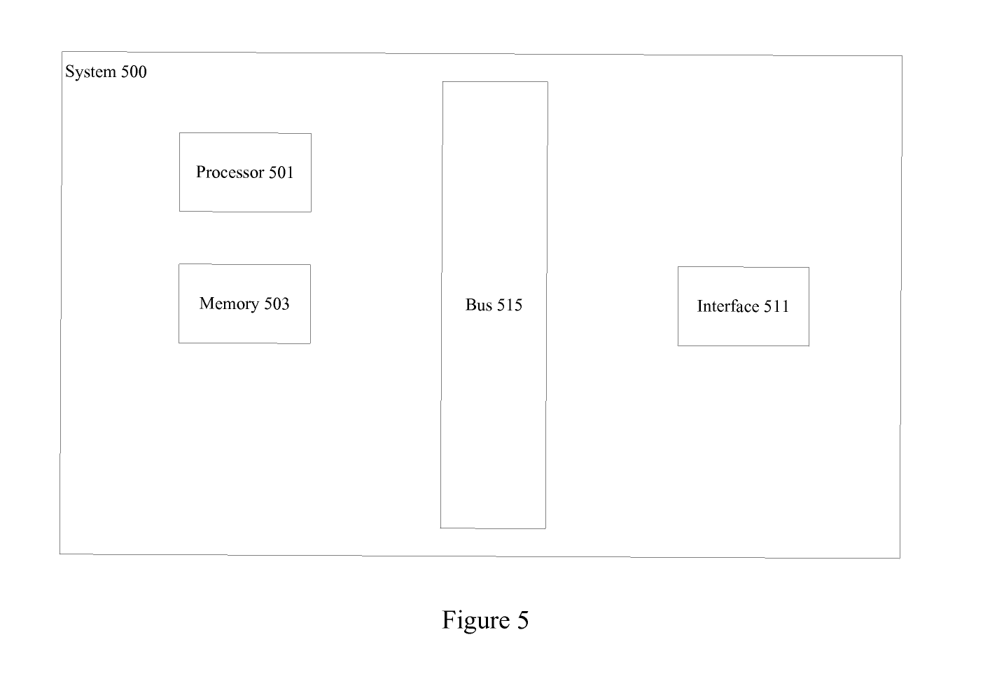

FIG. 5 illustrates one example of a server. According to particular embodiments, a system 500 suitable for implementing particular embodiments of the present invention includes a processor 501, a memory 503, an interface 511, and a bus 515 (e.g., a PCI bus or other interconnection fabric) and operates as a streaming server. When acting under the control of appropriate software or firmware, the processor 501 is responsible for modifying and transmitting media content to a client. Various specially configured devices can also be used in place of a processor 501 or in addition to processor 501. The interface 511 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 500 is a content server that also includes a transceiver, streaming buffers, and a program guide database. The content server may also be associated with subscription management, logging and report generation, and monitoring capabilities. In particular embodiments, the content server can be associated with functionality for allowing operation with mobile devices such as cellular phones operating in a particular cellular network and providing subscription management capabilities. According to various embodiments, an authentication module verifies the identity of devices including mobile devices. A logging and report generation module tracks mobile device requests and associated responses. A monitor system allows an administrator to view usage patterns and system availability. According to various embodiments, the content server handles requests and responses for media content-related transactions while a separate streaming server provides the actual media streams.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method comprising:
receiving a media content search term;
identifying a plurality of pieces of media content corresponding to the media content search term, wherein the media content search term may include correspondence to the title, description, and closed caption content of the plurality of pieces of media content;
returning the plurality of pieces of media content to the user, wherein a first piece of media content including the search term in the closed caption content is presented to the user with a plurality of markers depicting a plurality of time positions corresponding to the search term.

2. The method of claim 1, wherein the plurality of pieces of media content are ranked based on prominence of the search term in the title and description.

3. The method of claim 1, wherein the plurality of pieces of media content are ranked based on prominence of the search term in the closed caption content.

4. The method of claim 1, wherein the plurality of pieces of media content are ranked based on prominence of the search term and context terms related to the search term in the closed caption content.

5. The method of claim 1, wherein the plurality of pieces of media content are ranked based on prominence of the search term and context terms and the popularity of the plurality of pieces of media content.

6. The method of claim 1, wherein the plurality of pieces of media content are ranked based on prominence of the search term and context terms and the popularity of the plurality of pieces of media content for a demographic corresponding to the user.

7. The method of claim 1, wherein the plurality of pieces of media content are ranked based on prominence of the search term and context terms and the popularity of the plurality of pieces of media content based on the viewing profile of the user.

8. The method of claim 1, wherein selecting one of the plurality of markers displays a thumbnail.

9. The method of claim 1, wherein selecting one of the plurality of markers displays closed caption text corresponding to the search term.

10. The method of claim 1, wherein selecting one of the plurality of markers performs playback of a media segment.
